(19) United States
(12) Patent Application Publication
(10) Pub. No.: US 2016/0131307 A1
(43) Pub. Date: May 12, 2016

(54) METHOD FOR DETERMINING A HYDROGEN TANK PRESSURE

(71) Applicant: LINDE AKTIENGESELLSCHAFT, München (DE)

(72) Inventors: Wilfried-Henning REESE, Unterschleißheim (DE); Harald KRAUS, Munich (DE); Tobias KEDERER, Pullach (DE); Michael WESTERMEIER, Starnberg (DE)

(21) Appl. No.: 14/898,604

(22) PCT Filed: Jun. 26, 2014
(86) PCT No.: PCT/EP2014/001735

§ 371 Date: Dec. 15, 2015

(30) Foreign Application Priority Data
Jul. 2, 2013 (DE) 10 2013 011 052.1

(51) Int. Cl. F17C 5/02; F16K 15/00; F16K 17/02; G01L 7/02

(52) U.S. Cl. CPC F17C 5/02; G01L 7/024; F16K 15/00; F16K 17/02; F17C 2221/012; F17C 2223/0161; F17C 2225/0123; F17C 2250/0689

(57) ABSTRACT

A method for determining a tank pressure in a tank before the tank is filled with pressurised, gaseous hydrogen, according to which method an accumulator, in which the hydrogen to be used to fill the tank is stored as liquid hydrogen, is connected to the tank by means of a filling line and a subsequent check valve of the tank wherein hydrogen is pumped from the accumulator into the filling line by means of a pump and the filling-line pressure arising in the filling line during the pumping is measured, wherein the check valve is opened if the filling-line pressure exceeds the tank pressure, and wherein the tank pressure is determined as the filling-line pressure that exists when the check valve is opened.

The invention relates to a method for determining a tank pressure in a tank before the tank is filled with pressurized, gaseous hydrogen according to the preamble of claim 1.

Vehicles that take gaseous hydrogen as fuel require specially designed filling stations, which guide hydrogen exposed to a comparatively high pressure (up to 850 bar) into the vehicle tank. Such filling stations can exhibit a vacuum-insulated, cryostatic accumulator with liquid hydrogen (−253° C.), which serves as a reservoir for supplying hydrogen to the filling station. Since the hydrogen is to be present in the gaseous phase for filling purposes, such a filling station normally has gas buffer accumulators, which are supplied from the reservoir, and from which a tank (e.g., of a hydrogen-powered vehicle) is then filled.

In order to ensure the safety (explosion hazard) of the environment while filling vehicles of this kind and create a standard for the filling process, a consortium comprised of several vehicle manufacturers arrived at Standard SAE J2601. Among other things, the standard establishes safety-relevant limits and performance requirements for the filling process in particular of vehicles that lack onboard communication. SAE J2601 provides that hydrogen-powered vehicles be fueled to 700 bar within three minutes, without the temperature of the tank rising to in excess of a temperature of 85° C. in the process. In addition, Standard SAE J2601 provides that a pressure and tightness test be performed before filling the tank, among other things to ensure that the filling line of the filling station was correctly hooked up to the vehicle tank. During aforesaid pressure test, the initially unknown pressure in the tank of the vehicle is determined by having a pressure shock briefly open the tank with the filling line hooked up, so as to induce a pressure equalization between the filling line and tank of the vehicle. The pressure in the filling line then corresponds to the tank pressure of the tank.

The pressure shock for the pressure and tightness test is normally performed right from a gas buffer accumulator exposed to a high pressure, so that downstream elements in the filling line, e.g., pressure transmitters, thermometers, flowmeters, valves and screw connections, are directly exposed to this pressure shock (approx. 850 bar). In addition, soon a pressure test at the start of the actual filling process is often accompanied by another pressure peak in the downstream elements, which can be attributed to a pressurized residual volume. Such load changes in the filling line contribute to a more rapid, wearing of the downstream elements, and hence to a shortening of the service life for these components.

Proceeding from the above, the object of the present invention is to create a method for determining the tank pressure in a tank, in which such load changes in the filling line are ameliorated.

This object is achieved by a method with the features in claim 1.

The latter provides that the hydrogen is pumped from the accumulator into the filling line by a pump, and that the filling line pressure which here arises in the filling line is measured, wherein the check valve is opened if the filling line pressure exceeds the tank pressure, and wherein the tank pressure is determined as the prevailing filling line pressure when opening the check valve. The pump preferably involves a cryogenic pump, which pumps hydrogen out of the accumulator into the filling line at a constant mass flow, wherein said accumulator is in particular a vacuum-insulated, cryostatic accumulator.

The liquid hydrogen is preferably compressed by the pump before it is converted by a nigh-pressure evaporator into the gaseous phase, which then is led into the filling line.

In addition, such a pump is preferably designed as a piston pump, which pumps a specific volume per piston stroke into the filling line, in particular one corresponding to the cylinder volume of the piston pump. In this way, the pressure in the filling line can be increased in roughly a continuous manner, specifically until there is enough filling line pressure to push open the check valve.

It is here ensured that the pump can pressurize the filling line in particular to approx. 850 bar, so as to reliably open the check valve; the tank of the vehicle can be pressurized with hydrogen to at most 700 bar.

The pressure in the filling line is preferably acquired by a pressure transmitter, so that the progression of pressure in the filling line over time can be reconstructed. In particular when the check valve is open, the filling line pressure corresponds to the tank pressure. In one variant of the invention, the tank pressure is therefore determined based on the chronological progression of the filling line pressure.

In a preferred embodiment of the invention, the tank pressure is in ibis regard determined as the filling Line pressure that prevails after the chronological progression of the filling line pressure has leveled off. This holds true in particular when the check valve opens, and the volume to be pressurized by the pump becomes greater, since the tank represents an additional volume for the filling line. This lovers the pressure rise at a constant pump capacity.

In a variant of the invention, no additional hydrogen is initially pumped into the tank over a predefined timespan of preferably 5 to 25 seconds after the tank pressure has been determined for performing a tightness test on the filling line, wherein the filling line is presumed tight in particular given a constant chronological progression of the filling line pressure over that time span. A test is here performed in particular to determine whether the filling line has been correctly hooked, up to the vehicle tank, and whether one can rule out a leak in the connection to the tank, which would cause potentially significant quantities of hydrogen to escape during the ensuing filling process.

Given a tight filling line, the tank is preferably filled with hydrogen at a predefined pressure ramp, proceeding from the determined tank pressure. This takes place in particular at a constant pressure rate, which is selected in particular according to the aforementioned standard as a function of the ambient temperature and pressure in the vehicle tank.

Additional details and advantages of use invention are to he explained by the following descriptions to the figures of an exemplary embodiment based on the figures.

Shown on:

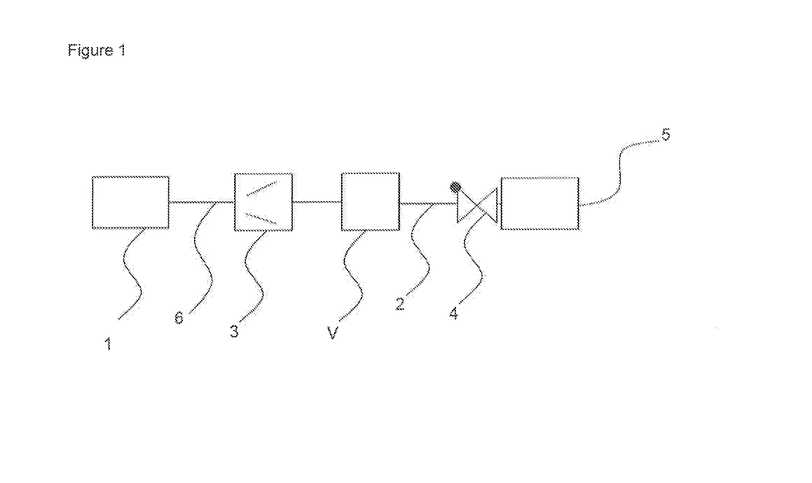

FIG. 1 is a schematic view of a device for filling a tank with gaseous hydrogen, and

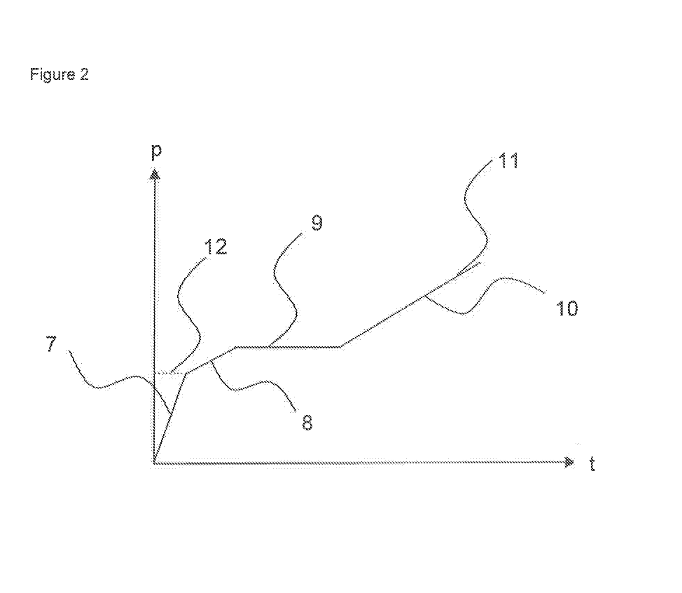

FIG. 2 is a schematic view of a pressure progression in the filling line during a pressure and tightness test and the ensuing filling of the tank.

FIG. 1 presents a schematic view of a device for filling a tank with gaseous hydrogen, which, exhibits an accumulator 1 that preferably stores liquid hydrogen. The accumulator 1 is here hooked up by means of a pump line 6 with a pump 3, which is connected with the tank 5 by means of a filling line 2 and a check valve 4 of the tank 5 to be filled.

FIG. 2 presents the schematic, chronological pressure progression 11 in the filling line 2 while implementing the method according to the invention. The filling line pressure p is here plotted on the ordinate, while the abscissa shows time t during the pressure and tightness test and the ensuing filling of the tank 5.

a pressure rise 7 is initially observed, which is caused by pressurizing the filling line 2 with the pump 3, but is at first too low to open the check valve 4 of the tank 5. As soon as the check valve 4 has been opened, by the continuous pumping of the pump 3, the pressure rise 8 levels off, since an additional volume, specifically that of the tank 5, must be pressurised. The tank pressure 12 prevailing in the tank 5 is now the filling line pressure p measured in the filling line 2. After determining the leveled pressure rise 8, the tightness test 9 is performed, during which no additional hydrogen is pumped into the tank 5 over a predefined time span. If the pressure 2 in the filling line 2 remains ideally constant, it its ay be concluded that the filling line 2 is tight or the connection with the tank 5 is sealed. As soon as the tightness test 9 has been successfully concluded, the actual filling process takes place with a predefined pressure ramp 10.

### REFERENCE LIST

| | |
|---|---|
| 1 | Accumulator |
| 2 | Filling line |
| 3 | Pump |
| 4 | Check valve |
| 5 | Tank |
| 6 | Pump line |
| 7 | Pressure rise in filling |
| | line |
| 8 | Leveling off of pressure |
| | rise |
| 9 | Tightness test |
| 10 | Pressure ramp |
| 11 | Pressure progression |
| 12 | Tank pressure |
| P | Filling line pressure |
| T | Time |
| V | High-pressure evaporator |

1. A method for determining a tank pressure in a tank before the tank is filled with pressurized, gaseous hydrogen, in which an accumulator that stores the hydrogen to be used for filling purposes as a liquid hydrogen is hooked up to the tank by means of a filling line and a subsequent check valve of the tank, characterized in that the hydrogen is pumped from the accumulator into the filling line by a pump, and the filling line pressure that here arises in the filling line is measured, wherein the check valve is opened if the filling line pressure exceeds the tank pressure, and wherein the tank pressure is determined as the prevailing filling line pressure when opening the check valve.

2. The method according to claim 1, characterized in that the liquid hydrogen is converted into the gaseous phase downstream from the pump which is then fed into the filling line.

3. The method according to claim 1, characterized in that the tank pressure is determined based on the chronological progression of the filling line pressure.

4. The method according to claim 1, characterized in that the tank pressure is determined as the filling line pressure that prevails after a leveling of the chronological progression of the filling line pressure.

5. The method according to claim 1, characterized in that no additional hydrogen is initially pumped into the tank over a predefined timespan after the tank pressure has been determined for performing a tightness test on the filling line, wherein the filling line is presumed tight over that time span.

6. The method according to claim 1, characterized in that the tank is filled with hydrogen at a predefined pressure ramp, proceeding from the determined tank pressure.

7. The method according to claim 2, characterized in that the liquid hydrogen is converted into the gaseous phase downstream from the pump by means of a high-pressure evaporator.

8. The method as claimed in claim 5, characterized in that the timespan of the fining line pressure is a constant chronological progression.
